(19) United States
(12) Patent Application Publication
(10) Pub. No.: US 2013/0263059 A1
(43) Pub. Date: Oct. 3, 2013

(54) METHOD AND SYSTEM FOR MANAGING AND DISPLAYING MUTLIMEDIA CONTENTS

(71) Applicants: Jose Antonio AMORAGA RODRIGUEZ, Barcelona (ES); Jorge ALIE CAPDEVILA, Barcelona (ES)

(72) Inventors: Jose Antonio AMORAGA RODRIGUEZ, Barcelona (ES); Jorge ALIE CAPDEVILA, Barcelona (ES)

(73) Assignee: INNOVATIVE ICROMS, S.L., BARCELONA (ES)

(21) Appl. No.: 13/588,290

(22) Filed: Aug. 17, 2012

(30) Foreign Application Priority Data
Mar. 28, 2012 (ES) P201230467

(51) Int. Cl. G06F 3/048

(52) U.S. Cl. 715/841

(57) ABSTRACT

The present invention relates to a method and system for managing and displaying multimedia contents, more specifically to a method and system which allows grouping multimedia contents into multimedia containers provided with a cover such that the transitions of the different multimedia contents of the multimedia container can be performed quickly and intuitively since the multimedia contents associated with the multimedia container the cover of which has been selected is displayed on the different faces of a polyhedron after selecting the cover of one of the multimedia containers. Said polyhedron can be a parallelepiped such as a cube, allowing the transition of the multimedia contents on the different faces of the cube by means of rotating the cube on its different axes.

### TECHNICAL FIELD OF THE INVENTION

The present invention relates to a method and system for managing and displaying multimedia contents, more specifically to a method and system which allows grouping multimedia contents into multimedia containers provided with a cover such that the transitions of the different multimedia contents of the multimedia container can be performed quickly and intuitively.

### BACKGROUND OF THE INVENTION

Methods and systems for managing and displaying multimedia contents which allow performing transitions within a sequential list of different multimedia contents such as photograph or video thumbnails to show them to a user such that he/she can browse through the different listed multimedia contents, allowing the activation of an operation to show the full multimedia content, for example, in a photograph viewer or video player when the user locates and selects a multimedia content of interest, are known.

Methods and systems for managing and displaying multimedia contents such as for example collections of virtual collectible cards as described in patent document U.S. Pat. No. 574,831 are also known. This document describes a method for displaying collectible cards in form of a list in a display area of a computer screen such that when the user selects one of them additional information associated with said collectible card is displayed in different subsections of the display area of the screen. However, the additional information which can be associated with each card is limited by the size of the display area on the screen, locating the contents is difficult since increasingly splitting the display area of the screen into different subsections upon introducing new additional information is required.

Patent document WO0250752 presents a player for virtual collectible cards forming part of a collection in which each card is associated with different multimedia contents organized in layers. Each of the layers can be accessed by means of the player, one by one, the multimedia content corresponding to each layer being shown in the entire display area of the screen, the user being able to sequentially access the different multimedia contents by following a specific sequence, therefore the transition of multimedia contents provided between layers far from one another being slow.

Therefore an objective of the present invention is to disclose a method and system for managing and displaying multimedia contents which allows accessing several multimedia contents and browsing them quickly and intuitively.

### DISCLOSURE OF THE INVENTION

The method for managing and displaying multimedia contents of the present invention is of the type which comprise the steps of designating at least one multimedia container; linking every designated multimedia container to multimedia contents; establishing for each multimedia container one of the linked multimedia contents as the cover of the multimedia container; and displaying at least one cover of the multimedia container for selection.

The method is essentially characterized in that upon selecting the cover of one of the displayed multimedia containers, the multimedia contents linked to said multimedia container are shown on the different faces of a polyhedron allowing the transition of the multimedia contents on the different faces of the polyhedron by means of rotating the polyhedron, from which a three-dimensional virtual view is shown on screen, on its different axes, allowing the quick transition of the different multimedia contents, such as for example videos, which can be played simultaneously on the different faces of the polyhedron, further resulting in greater dynamism and facilitating the identification of a multimedia content of special interest. It is also possible that a plurality of polyhedrons is shown upon selecting the cover of one of the multimedia containers.

In one variant of the invention, the polyhedron can have several faces, this being, for example, a parallelepiped with four faces, in a variant of interest said parallelepiped being a cube since its different faces are square and the same and therefore being able to enclose square multimedia contents without needing to specify a specific height to length ratio for each face.

In one variant of the invention, at least one of the multimedia contents on the faces of the polyhedron is linked to an audiovisual event, the execution of said audiovisual event being triggered by selecting the face of the polyhedron on which the multimedia content to which it is linked is shown, allowing to play the audiovisual events linked to the multimedia contents of the faces. Naturally, it is possible that said audiovisual event entails the viewing of a secondary polyhedron, similar to the first, which in turn shows other multimedia contents.

In another variant of the invention, the method further comprises the subsequent step of modifying the multimedia contents initially linked to a multimedia container to update the multimedia contents on the different faces of the polyhedron and to thus enable updating said initially linked multimedia contents. Naturally warning mechanisms are provided to enable notifying when a multimedia container has changed its multimedia contents to thus favor its viewing.

In another variant of the invention, the number of different multimedia contents linked to a multimedia container is seven, one of them corresponding to the cover and the rest corresponding to the different faces of the polyhedron, whereas in another variant of the invention, the number of different multimedia contents linked to a multimedia container is less than seven, in the case that the polyhedron is a cube, at least one of the faces of the cube being able to be empty which face can be subsequently filled, for example by the user by incorporating a customized multimedia content to one of the empty faces.

In another variant of the invention, the multimedia contents comprise images, said images being shown in the corresponding faces of the polyhedron, as long as they are visible while the polyhedron rotates, the multimedia contents also being able to comprise videos, said videos being shown on the corresponding faces of the polyhedron. The videos can initially be paused, allowing the user to determine the time at which they are played or can simply be played on the different faces of the polyhedron, the simultaneous viewing of different videos by means of rotating the polyhedron being facilitated.

In another variant of the invention, the linking of each multimedia container to multimedia contents and the establishment of one of the linked multimedia contents as the cover of the multimedia container, as well as the designation of the multimedia contents which will be on each of the different faces of the polyhedron are recorded in a multimedia container database.

In another variant of interest, identifiers of the respective multimedia contents are recorded in the multimedia container database facilitating changing the multimedia contents by simply modifying the identifier recorded for a specific face of the polyhedron.

In another variant of the invention, the multimedia containers form part of a finite set of elements such that the maximum number of multimedia containers can be provided in advance.

In another variant of the invention, each of the multimedia containers forms part of a finite set of collectible elements and is associated with a set of users owning said multimedia container, allowing the easy association and disassociation of each of the multimedia containers of the users owning said multimedia container.

In another variant of the invention, the multimedia containers forming part of a finite set of collectible elements are transferable from a user owning said multimedia container to a user not owning said multimedia container, allowing obtaining the collectible elements which one does not own by means of trading those collectible elements that are repeated.

The system for managing and displaying multimedia contents is characterized in that it comprises storage means for storing multimedia contents; means for designating multimedia containers and linking them to the multimedia contents of the storage means, establishing for each multimedia container one of the multimedia contents as the cover of the multimedia container and other multimedia contents as faces of a polyhedron. The system further comprises a server for receiving connections of user client devices and transmitting the covers of the multimedia containers to said user client devices and after receiving the cover selection from each user device, providing the multimedia contents linked to its multimedia container to be shown in the user device, for example on a computer screen, on the different faces of a polyhedron in a virtual three-dimensional environment, allowing the user client device the transition of the multimedia contents on the different faces of the polyhedron by means of rotating the polyhedron on its different axes.

In one variant of the invention, the storage means also store audiovisual events linked to the multimedia contents which are transmitted to the user client devices by selecting one of the previously transmitted multimedia contents.

In one variant of the invention, the server comprises means for receiving connections of administrators for creating new multimedia containers or modifying the existing multimedia containers, linking them to other multimedia contents of the storage means to thus enable updating the multimedia containers.

In one variant of the invention, the administrator device can incorporate multimedia contents or audiovisual events in the storage means, establishing or modifying links of said multimedia contents and audiovisual events and to thus enable providing new multimedia contents and new audiovisual events and both linking them with the new multimedia contents and updating those previously linked to the existing multimedia contents.

### BRIEF DESCRIPTION OF THE DRAWINGS

To complement the description that is being made and for the purpose of aiding to better understand the features of the invention, a set of drawings is attached to the present specification in which the following has been depicted with an illustrative and non-limiting character FIG. 1a shows a sequence of multimedia contents;

FIG. 1b shows a table with the transition cost of the multimedia contents of FIG. 1a;

FIG. 2a shows a sequence of multimedia contents according to the invention;

FIG. 2b shows a table with the transition cost of the multimedia contents of FIG. 2a;

FIG. 2c shows a polyhedron in the shape of a cube for performing the sequence of multimedia contents of FIG. 2a in an exploded view;

FIG. 2d shows a perspective view of the cube of FIG. 2c for performing the sequence of multimedia contents of FIG. 2a;

FIG. 3 shows a set of multimedia contents linked to audiovisual events;

FIG. 4 shows a table for recording multimedia containers;

FIGS. 5a, 5b are exploded views of the polyhedrons in the shape of a cube with the multimedia contents defined in the table of FIG. 4;

FIG. 6a shows a first action for displaying and managing a multimedia container;

FIG. 6b shows a second action for displaying and managing the multimedia container of FIG. 6a;

FIG. 6c shows a third action for displaying and managing the multimedia container of FIG. 6a;

FIG. 7 shows a system according to the invention;

FIG. 8 shows a process for obtaining collectible multimedia containers;

FIG. 9 shows an action for displaying and managing several of the multimedia containers obtained by means of the process of FIG. 8;

FIG. 10a shows a state prior to a trading of multimedia containers among users;

FIG. 10b shows a state after the trading of FIG. 10a;

FIG. 11 shows an action of displaying and managing multimedia contents in an e-commerce application.

### DETAILED DESCRIPTION OF EMBODIMENT VARIANTS

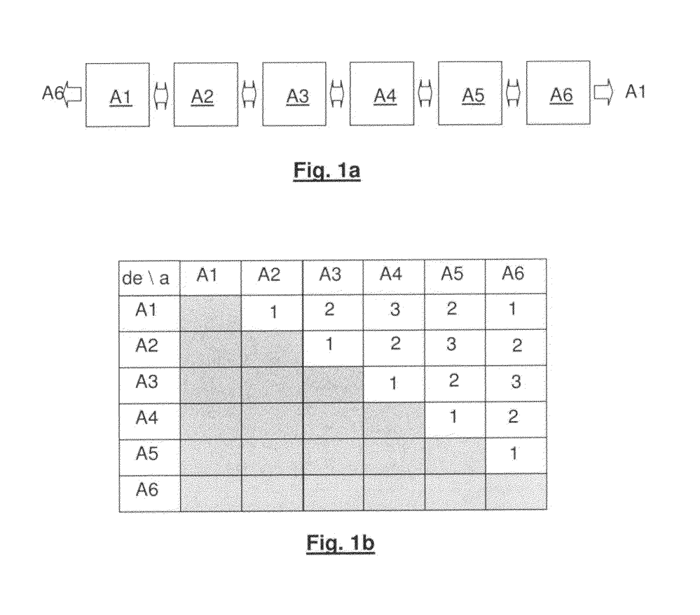

FIG. 1a shows the sequence in which a plurality of multimedia contents A1, A2, A3, A4, A5, A6, such as photographs for example, allow their cyclic transition from one to another in a known manner. It is normal that when a user views a set of multimedia contents A1, A2, A3, A4, A5, A6 he/she is presented with a view with the first multimedia content A1 and therefrom, by means of using cursors or other displacement means for moving between images he/she can move to the second multimedia content A2 or to the sixth multimedia content A6, therefore the cost of the transition of the first multimedia content A1 to the second multimedia content A2 or to the sixth multimedia content A6 being one transition as shown in the table of FIG. 1b. Similarly, both the third multimedia content A3 can be reached and the first multimedia content A1 can be returned to from the second multimedia content A2, also with a cost of one transition. The transition costs thus accumulate, therefore the cost of transition of the first multimedia content A1 to the third multimedia content A3 being two because it must first pass through the second multimedia content A2. The different transition costs of multimedia contents A1, A2, A3, A4, A5, A6 are summarized in the table of FIG. 1b in which it can be seen that the transition cost can go up to three, therefore using the displacement means a few times to enable moving between all the multimedia contents A1, A2, A3, A4, A5, A6 provided in a cyclic transition being necessary. This cost may prevent the user, for example, starting from the first multimedia content A1, from reaching the fourth multimedia content A4 having a cost of three transitions, therefore it is possible that important information contained in said fourth multimedia content A4 is ignored by the user.

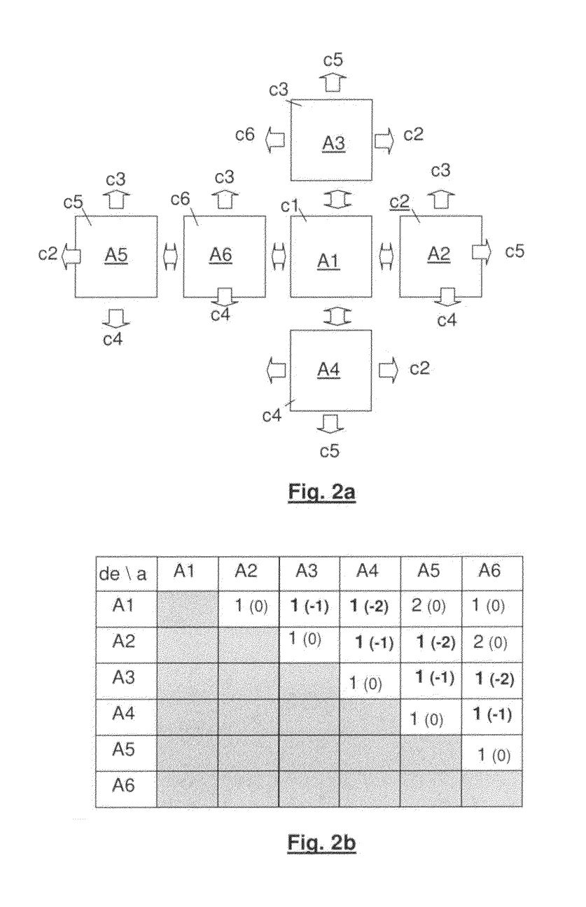

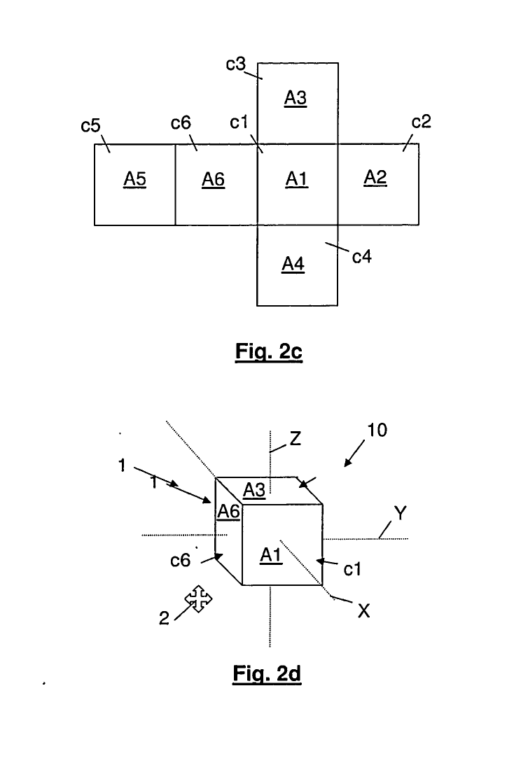

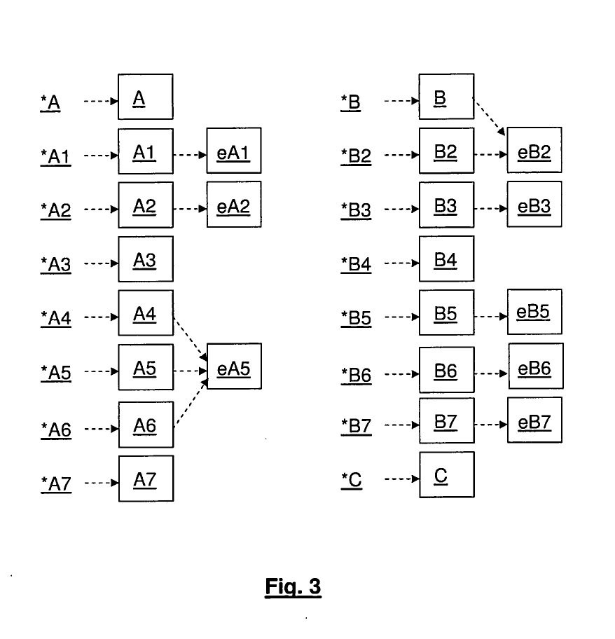

Modifying the transactions of multimedia contents A1, A2, A3, A4, A5, A6 as specified in FIG. 2a substantially improves the cost of transactions for an environment of up to six multimedia contents A1, A2, A3, A4, A5, A6. Like the table of FIG. 1b the table of FIG. 2b shows the cost of the transactions of multimedia contents A1, A2, A3, A4, A5, A6 providing the transactions of said multimedia contents A1, A2, A3, A4, A5, A6 as specified in FIG. 2a. Besides indicating the transaction cost of two multimedia contents A1, A2, A3, A4, A5, A6 the squares of the table of FIG. 2b indicate in brackets the difference of the transaction cost with respect to the transaction cost of the same multimedia contents A1, A2, A3, A4, A5, A6 provided according to FIG. 1a. It can be verified that the improvement in transaction cost is substantial, in no case is the cost worsened when changing from the transactions according to FIG. 1a to the transactions according to FIG. 1b and being improved in several cases between one and two transactions. The user can thus have easier access to all the multimedia contents A1, A2, A3, A4, A5, A6 their browsing being facilitated.

To facilitate browsing the multimedia contents A1, A2, A3, A4, A5, A6 following the transactions described in FIG. 2a, the different multimedia contents are respectively provided on the faces c1, c2, c3, c4, c5, c6, which in the variant shown are squares, of a multimedia container in the shape of a polyhedron, said polyhedron being for example a parallelepiped in the shape of a cube 1 which is shown in FIG. 2c. Naturally the multimedia contents could be provided on faces having other shapes. For example, if the faces are triangular the multimedia container could have the shape of a tetrahedron or an octahedron, also having advantages in the transitions of multimedia contents provided on the different faces in a manner similar to that demonstrated above. Naturally the polyhedrons can be either regular and irregular polyhedrons or a rhombus depending on whether their faces c1, c2, c3, c4, c5, c6 are the same or different, and even be open or closed. In an extreme variant in which there is only a single face, the polyhedron will be simply a polygonal surface. Two faces could also be established in the form of a smooth polygonal surface provided with a front face and a rear face.

FIG. 2c shows the multimedia container in the shape of a cube 1 in an exploded view in which the multimedia contents A1, A2, A3, A4, A5, A6 can be seen each provided on one of the respective faces c1, c2, c3, c4, c5, c6 of the cube 1 and FIG. 2d shows the multimedia container in a three-dimensional perspective view, in the way in which it will be presented to the user, for example in a three-dimensional viewing environment of the types known in the state of the art for showing three-dimensional objects which give a feeling of browsing in a three-dimensional space on a computer screen to facilitate browsing the different multimedia contents A1, A2, A3, A4, A5, A6 with a lower transition cost. As can be seen in FIG. 2d, only some of the multimedia contents will be visible according to the position of the cube 1, specifically in the position shown in FIG. 2d the faces c1, c3 and c6 showing the respective multimedia contents A1, A3, A6 can be seen. Even though in the variant shown the parallelepiped is a cube 1, because advantageously in this manner all the faces c1, c2, c3, c4, c5, c6 are the same and the multimedia contents A1, A2, A3, A4, A5, A6 can be indifferently assigned to one of them, the parallelepiped could also be a octahedron, a rhombohedron, which in these cases enclose the multimedia contents A1, A2, A3, A4, A5, A6 corresponding to their dimensions or leave, for example, the part of the face c1, c2, c3, c4, c5, c6 not covered by the multimedia contents A1, A2, A3, A4, A5, A6 in black.

Other multimedia contents A1, A2, A3, A4, A5, A6, which can be still images or image sequences such as a video are browsed by means of rotating the cube 1 in its respective axes X, Y, Z. This rotation can be performed by means of using cursors or other displacement means such as for example a three-dimensional control pictogram 2 which can be activated by means of the pointer 3 of a mouse as shown in FIG. 2d to perform the transitions of the different faces c1, c2, c3, c4, c5, c6 and to thus enable showing their respective multimedia contents A1, A2, A3, A4, A5, A6 as will be shown below. The image sequences such as a video can be played at the user's will or constantly, for example playing the same video repeatedly even while the cube 1 rotates.

Naturally these transitions of the different faces c1, c2, c3, c4, c5, c6 will occur progressively such that the user has the feeling of really rotating a cube 1 by selecting, by means of the pointer 3, the points of the three-dimensional control pictogram 2 corresponding to the rotation of each of the axes X, Y, Z, bringing about an effect of three-dimensionality and realism while the cube 1 rotates.

The user can easily browse through the different faces c1, c2, c3, c4, c5, c6 of the cube 1 in the manner shown above until locating a multimedia content A1, A2, A3, A4, A5, A6 of his/her interest. After locating said multimedia content A1, A2, A3, A4, A5, A6 of interest, the user can select it by means of the pointer 3 to thus trigger the execution of an audiovisual event eA1, eA2, eA5, eB, eB2, such as for example a video linked to the selected multimedia content A1, A2, A3, A4, A5, A6, as long as the audiovisual event eA1, eA2, eA5, eB, eB2 has been previously linked to the selected multimedia content A1, A2, A3, A4, A5, A6 in a manner which will be described below.

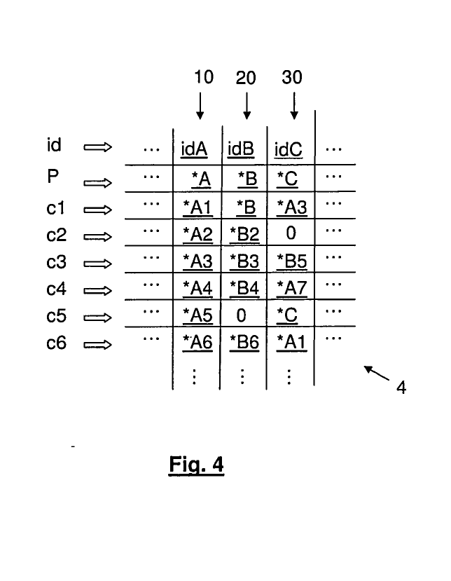

FIG. 3 shows the links of multimedia contents A1, A2, A3, A4, A5, A6 which are shown on one of the faces c1, c2, c3, c4, c5, c6 of the cube 1, in the manner described above, and which trigger the execution of an associated audiovisual event eA1, eA2, eA5, eB, eB2 upon selecting, for example by means of the pointer 3 of the mouse, the multimedia contents A1, A2, A3, A4 A5, A6 with which they are associated. Said audiovisual events eA1, eA2, eA5, eB, eB2 can be for example videos which are played adjacent to the cube 1, sets of photographs to be examined or the audiovisual event can even consist of activating a link to a network address to assess a page in which more information is provided or can participate in promotions or contests. The audiovisual event eA1, eA2, eA5, eB, eB2 could also consist of the appearance of a secondary cube 1. Naturally the associations of multimedia contents A1, A2, A3, A4, A5, A6 and audiovisual events eA1, eA2, eA5, eB, eB2 can be modified as specified by a system administrator or a user to whom the administrator has given enough permissions. New audiovisual events eA1, eA2, eA5, eB, eB2 can thus be incorporated to replace some of the previous audiovisual events eA1, eA2, eA5, eB, eB2 or to simply reorganize the associations of the multimedia contents A1, A2, A3, A4 A5, A6 and the audiovisual events eA1, eA2, eA5, eB, eB2. For example, it can be seen that in the same way that there are audiovisual events associated with a single multimedia content, for example multimedia content A1 and audiovisual event eA1, there are also audiovisual events associated with several multimedia contents, for example multimedia contents A4, A5, A6 and audiovisual event eA5.

To reuse multimedia contents A1, A2, A3, A4, A5, A6 in different cubes 1 it is possible to use references *A1, *A2, *A3, *A4, *A5, *A6 for each of said multimedia contents A1, A2, A3, A4, A5, A6, to enable accessing said multimedia contents A1, A2, A3, A4, A5, A6 more efficiently.

It is possible to use references *A, *A1, *A2, *A3, *A4, *A5, *A6 for each of said multimedia contents A, A1, A2, A3, A4, A5, A6 to establish the multimedia contents A1, A2, A3, A4, A5, A6 which will be on each of the faces c1, c2, c3, c4, c5, c6 of each cube 1 in a multimedia container recording database 4. For example said references *A, *A1, *A2, *A3, *A4, *A5, *A6 can consist of the network address in which the corresponding multimedia content A1, A2, A3, A4, A5, A6 can be found.

Therefore, a system administrator or a user to whom the administrator has given enough permissions will be able to modify the records of the multimedia container database 4 to thus, in addition to enabling the creation of new multimedia containers describing new cubes 1, enable the substitution of references *A, *A1, *A2, *A3, *A4, *A5, *A6 of the existing cubes 1 to thus enable introducing new multimedia contents in the existing cubes 1, replacing said references *A, *A1, *A2, *A3, *A4, *A5, *A6 with other references to other multimedia contents.

By way of example FIG. 4 describes a multimedia container database 4 in which the information for three different cubes 1 has been depicted, the information being depicted for a multimedia container 10, 20, 30 in each column and each multimedia container 10, 20, 30 comprising information of the different multimedia contents A1, A2, A3, A4, A5, A6 associated with each of the faces c1, c2, c3, c4, c5, c6 of a cube 1.

As can be verified in the multimedia container database 4 of FIG. 4, the information referring to the first multimedia container 10 corresponds to the cube 1 depicted previously in FIGS. 2c and 2d, the values referring to faces c1, c2, c3, c4, c5, c6 being seen to correspond to the references *A1, *A2, *A3, *A4, *A5, *A6 of the multimedia contents A1, A2, A3, A4, A5, A6. It can also be seen that the information of each multimedia container 10, 20, 30 also comprises a value of cover P this being a reference *A to a multimedia content A which will be shown as the representation of the first multimedia container 10, for example for selecting it from several covers P, by way of an index. It also comprises a value of identifier id, which in the case of the first multimedia container 10 will be idA and which will allow making references to said first multimedia container 10, and therefore its corresponding cube 1 in other tables, for example in a table for linking multimedia containers 10, 20, 30 with owners of said multimedia containers 10, 20, 30. Naturally, other information such as extra multimedia contents which can additionally be displayed in the cube 1 can also be recorded in the multimedia container database 4, for example if the user uses a special functionality of the cube 1, for example enlarging or opening it. These special functionalities can be executed simply by means of the three-dimensional control pictogram 2 or by means of random combinations of commands by way of surprise functionality of the cube 1.

It can be seen in the information of the second multimedia container 20 that the multimedia content of the first face c1 corresponds to that of its cover P and that the multimedia content associated with the fifth face c5 is empty as its reference is, for example, zero. The fact that it is empty indicates that the option of enabling the addition of a multimedia content of his/her choice to said empty face c5 will be presented to the user, as will be seen below, said multimedia content being able to be both a multimedia content belonging to the user, for example a photograph stored in his/her computer and a multimedia content to be chosen from a list of multimedia contents provided by the system.

In the third multimedia container 30 references to multimedia contents which have already been referred to previously by the first multimedia container 10 and by the second multimedia container 20 have been used.

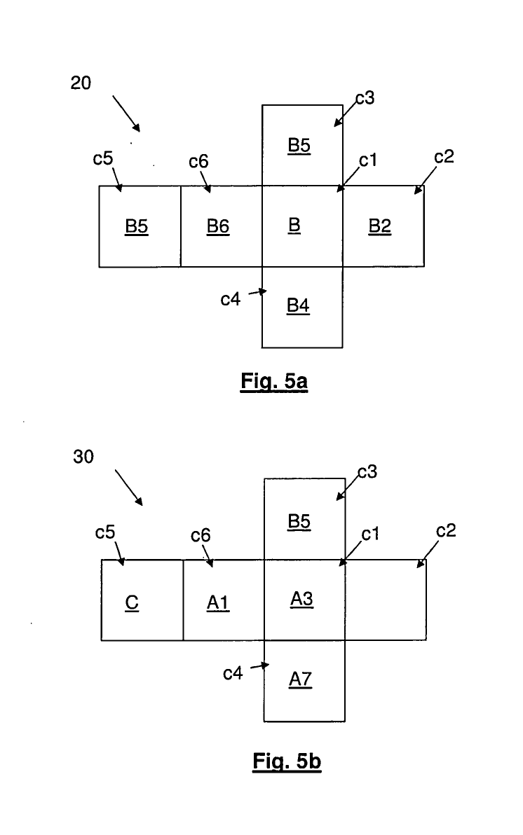

FIGS. 5a and 5b respectively show the cube 1 corresponding to the second multimedia container 20 and the cube 1 corresponding to the third multimedia container 30 as has been previously specified in the multimedia container database 4 of FIG. 4 in exploded views so that it can be seen that the different multimedia contents linked on the different faces c1, c2, c3, c4, c5, c6 are present on the faces of each cube 1.

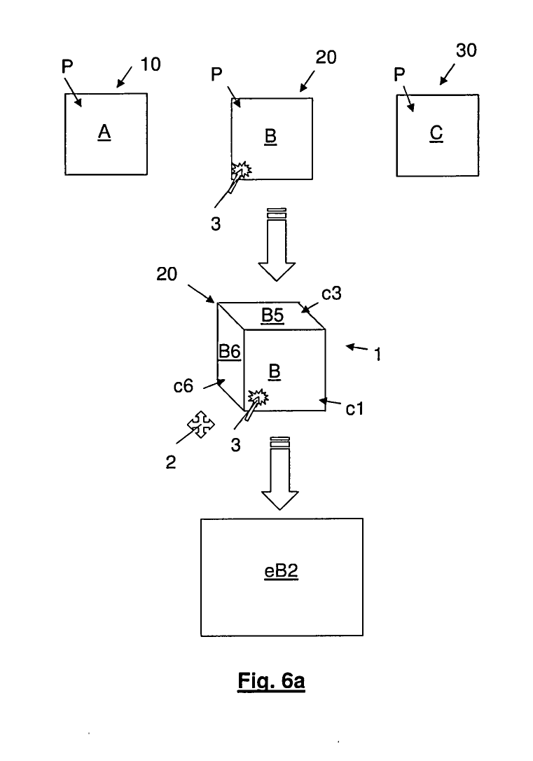

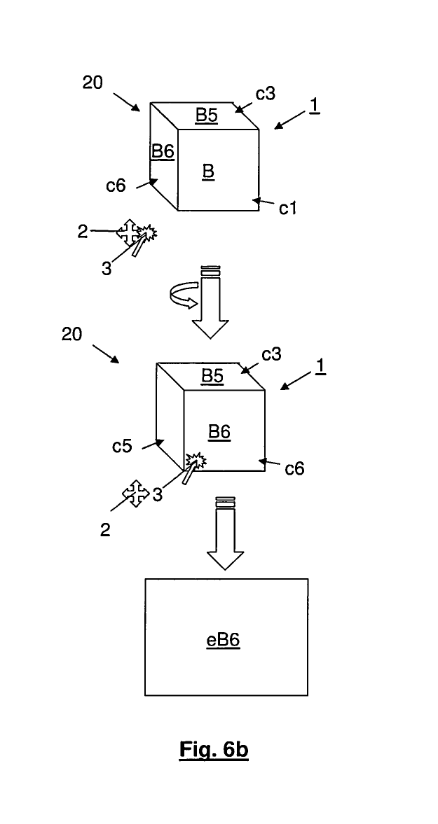

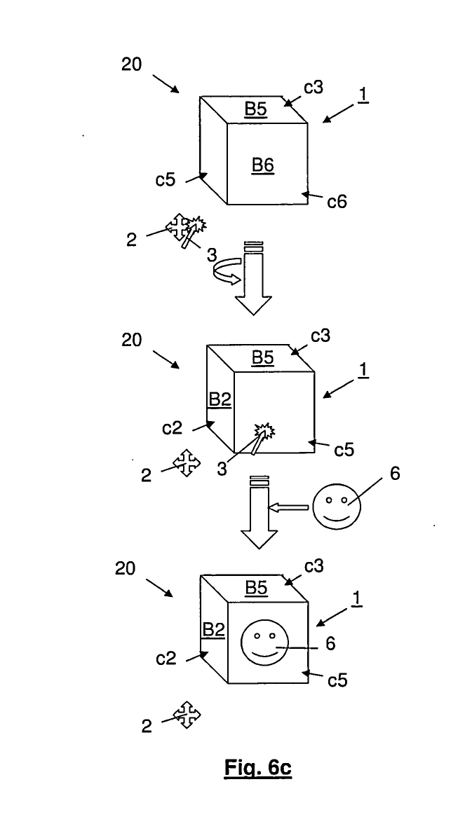

FIG. 6a shows the cover P of each of the multimedia containers 10, 20, 30, the multimedia content A being the one corresponding to the cover P of the first multimedia container 10, the multimedia content B being the one corresponding to the cover P of the second multimedia container 20 and the multimedia content C being the one corresponding to the cover P of the third multimedia container 30. Said multimedia contents corresponding to each cover P are displayed such that the user can select the desired one by means of the pointer 3 for example, to enable accessing the multimedia contents associated with the faces of the cube 1 of each multimedia container 10, 20, 30 which have been previously recorded in the multimedia container database 4 together with each cover P for each multimedia container 10, 20, 30.

As seen in FIG. 6a, when the user selects the multimedia content B corresponding to the cover P of the second multimedia container 20, the multimedia contents B, B2, B3, B4 and B6 previously linked to the second multimedia container 20 will be shown, each of these multimedia contents B, B2, B3, B4 and B6 being on one of the different faces c1, c2, c3, c4, c5, c6 of the cube 1 as specified in the multimedia container database 4. Like the cube 1 described previously in FIG. 2b, said cube 1 allows the transition of multimedia contents adjacent to one another by means of rotating the cube 1 on its different axes X, Y, Z, for example by means of using a three-dimensional control pictogram 2 through the pointer 3.

In addition to being able to rotate the cube 1 on their different axes, it is also possible to select the multimedia contents on each of the faces c1, c2, c3, c4, c5, c6 of the cube 1. FIG. 6a shows the selection of the multimedia content B on the first face c1 of the cube 1 by means of the pointer 3 triggering the execution of the linked audiovisual event eB2 which, for example, can be a video linked to the multimedia content B.

After the user executes the audiovisual event eB2 or interrupts said audiovisual event eB2, the view of the cube 1 is restored as shown at the start of the sequence of FIG. 6b. After selecting the right part of the three-dimensional control pictogram 2 through the pointer 3 of the mouse the cube 1 is rotated being able to thus select the multimedia content B6 on the sixth face c6 of the cube 1 by means of the pointer 3 triggering the execution of the linked audiovisual event eB6. Another operating example of the cube 1 is shown in FIG. 6c in which the cube 1 is rotated in the manner described above to select the fifth face c5 of the cube 1 which does not have any linked audiovisual content. In this case, the user can provide his/her own audiovisual content 6 which will be associated with the fifth face c5 of the second multimedia container 20.

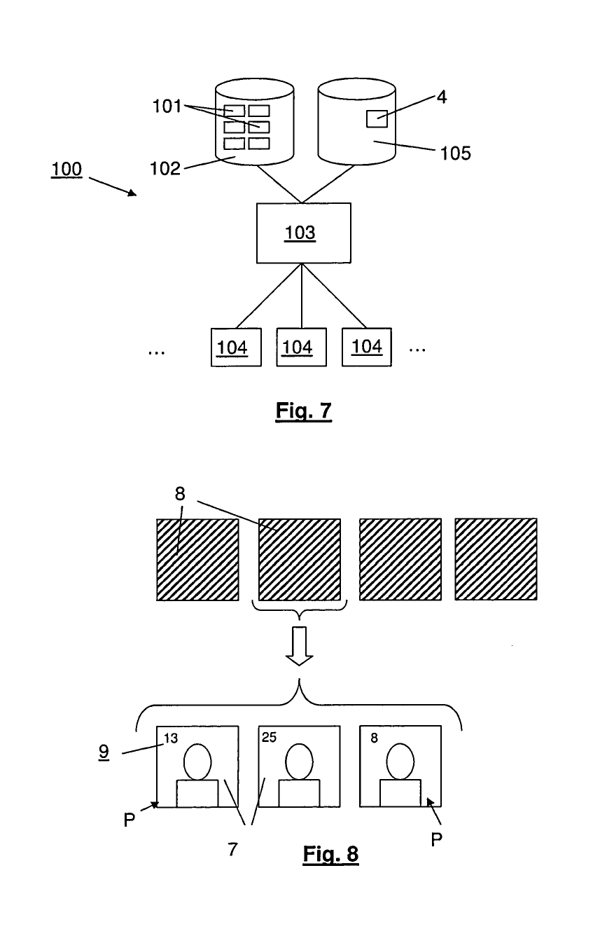

The multimedia contents A, A1, A2, A3, A4, A5, A6, B, B2, B3, B4, B5, B6, B7, C are stored in the form of files 101 in storage means 102 which can be accessed through a network as shown in the system 100 of FIG. 7. This storage can be both a centralized storage and can be replicated in different servers for quick access, determining a type of storage usually known as “cloud” storage. To transfer the multimedia contents A, A1, A2, A3, A4, A5, A6, B, B2, B3, B4, B5, B6, B7, C corresponding to each client, there is provided a server 103 to which different devices are connected. Said server 103 can be a centralized server or a plurality of servers linked to one another to simultaneously attend to a large amount of requests. The server 103 is prepared for receiving connections of user client devices 104 and has access to recording means 105 comprising the multimedia container database 4 in which multimedia containers 10, 20, 30 are designated and linked to the multimedia contents A, A1, A2, A3, A4, A5, A6, B, B2, B3, B4, B5, B6, B7, C of the storage means 102, therefore the server 103 can determine, for each multimedia container 10, 20, 30, the multimedia content A, A1, A2, A3, A4, A5, A6, B, B2, B3, B4, B5, B6, B7, C designated as the cover P of each multimedia container 10, 20, 30 and the multimedia contents A, A1, A2, A3, A4, A5, A6, B, B2, B3, B4, B5, B6, B7, C designated as faces c1, c2, c3, c4, c5, c6 of the cube 1 thereof by consulting the multimedia container database 4.

Therefore, the server 103 can initially transmit the covers P of the multimedia containers 10, 20, 30 to the user client devices 104 and, after each user client devices 104 receives the selection of cover P, providing the multimedia contents A, A1, A2, A3, A4, A5, A6, B, B2, B3, B4, B5, B6, B7, C linked to the multimedia container 10, 20, 30 selected for showing the different faces c1, c2, c3, c4, c5, c6 of the cube 1 corresponding to the selected multimedia container 10, 20, 30, for example on a computer screen, the user client device 104 allowing the user to perform the transition of the multimedia contents on the different faces of the cube by means of rotating the cube on its different axes X, Y, Z in the manner described above.

The files 101 of the storage means 102 also comprise audiovisual events eA1, eA2, eA5, eB2, eB3, eB5, eB6 of those linked to the multimedia contents A, A1, A2, A3, A4, A5, A6, B, B2, B3, B4, B5, B6, B7, C which are stored both in the form of photograph and video files and links to network addresses or even programs or lists of commands to be executed when the corresponding audiovisual event eA1, eA2, eA5, eB2, eB3, eB5, eB6 is requested.

Naturally, the server 103 allows receiving connections of administrator client devices 104, which after being duly identified, for example by providing administrator credentials, allows creating new multimedia containers 10, 20, 30 or modifying the existing multimedia containers 10, 20, 30 by adding new files 101 of multimedia contents and of audiovisual events. An administrator can also substitute the multimedia contents A, A1, A2, A3, A4, A5, A6, B, B2, B3, B4, B5, B6, B7, C initially linked to a multimedia container 10, 20, 30 to link them to other multimedia contents of the storage means 102 which may have been incorporated by the same administrator, as well as to new audiovisual events eA1, eA2, eA5, eB2, eB3, eB5, eB6. Naturally, the administrators will only be able to incorporate and manipulate those sets of multimedia containers, multimedia contents and audiovisual events to which the corresponding permissions have been given.

A relevant application of the method described above is the management of a finite set of collectible elements 7 such as trading cards. Therefore advantageously each collectible element 7 can be considered not simply as a still image but a multimedia container 10, 20, 30, whereby the users will obtain, in each collectible element 7, not only a still image which will correspond to the cover P of the multimedia container but can also select said cover P and browse through the multimedia contents on the different faces of the cube 1, accessing the audiovisual events which have been associated with each multimedia content in the manner described above. FIG. 8 shows a source of collectible element packs 8 allowing a subsequent purchasing process, for example by means of a credit card or by means of introducing a prepaid gift card, to obtain a set of collectible element packs 8. To make it more intriguing, said collectible element packs 8 will be presented to the user covered up and showing a plurality of them, such that the user will be the one who must decide which of the collectible element packs 8 displayed to select. Each collectible element pack 8 comprises therein a pre-determined number of collectible elements 7, being for example three in the variant shown in FIG. 8. After the user selects one of the collectible element packs 8, the three collectible elements 7 contained in the selected collectible element pack 8 are uncovered. Each of said collectible elements 7 corresponds to a multimedia container from which the multimedia content of cover P thereof will be initially shown. To make it more similar to a traditional trading card collection each multimedia content of cover P will also show a collection sequence number 9. After showing the cover P of the collectible elements 7 they will become part of the user's collection 11, the identifiers of each multimedia container 12 being associated with the identifier of the user 13 in a database.

It is also possible to acquire collectible elements 7 individually, for example specific collectible elements 7 or special collectible elements 7 usually at a higher price than that of the collectible element packs 8. This case can also be contemplated for collectible elements 7 which are only available for acquisition during a specific time period or are linked to multimedia contents with greater added value.

Before a user acquires collectible elements 7, the user must be registered through a registration process in the system, for example by initially providing name, e-mail and pseudonym to be used. Additionally, the user can also provide other data such as his/her nationality, presence in social networks and even an image whereby the user is identified as an avatar. Registration will be necessary for all users with the exception of those wishing simply to obtain a prepaid gift code which will subsequently be used by a registered user in the manner described above. Naturally said prepaid gift code can be obtained by means of a virtual financial transaction as well as in physical gift cards containing a prepaid gift code which can be acquired in physical shops such as a newsstand.

After obtaining collectible elements 7 in the manner described above the user can view his/her collectible elements 7 wherein the covers P of the multimedia containers corresponding to the collectible elements 7 which are recorded as being owned by the user are shown, displayed in sequence, allowing the user to browse them sequentially. To ensure that the collectible elements 7 form part of a collection 11 and to encourage the user to continue with the collection 11 until obtaining all the collectible elements 7 forming part of the collection 11 the collectible elements 7 are ordered by their collection sequence number 9 emphasizing, for example with a grey image, those collectible elements 7 which the user has yet to obtain.

The user is also informed of the repeated collectible elements 7 by means of a counter 14 which is presented to the user together with each collectible element 7. Naturally since each collectible element 7 is a multimedia container, this can show the cube 1 with the multimedia contents which have been previously assigned to the faces of the multimedia container of the collectible element 7 and browse through the multimedia contents on the different faces of the cube 1 through the three-dimensional control pictogram 2 operated by means of the pointer 3 of the mouse in the manner described above. Alternatively to the three-dimensional controls 2, in a touch device the user can browse through the different faces of the cube 1 by simply moving his/her finger along the screen of the touch device in the desired direction. To change the cube 1 of the shown multimedia container to the cube 1 of the multimedia container with the adjacent cover P, the user can use special controls or touch devices to make a long line with his/her finger on the touch screen of the device in the direction of the adjacent cover P by means of a transition effect.

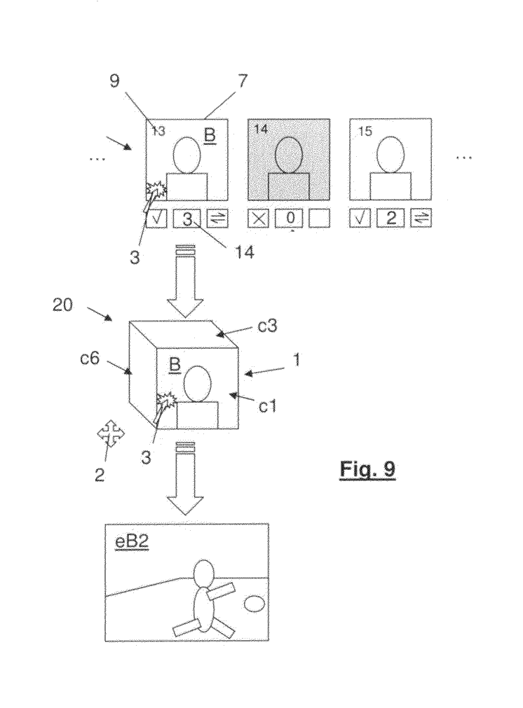

The user can also access the audiovisual event which has been associated with each multimedia content by selecting the corresponding face of the cube, for example as shown in the sequence of FIG. 9.

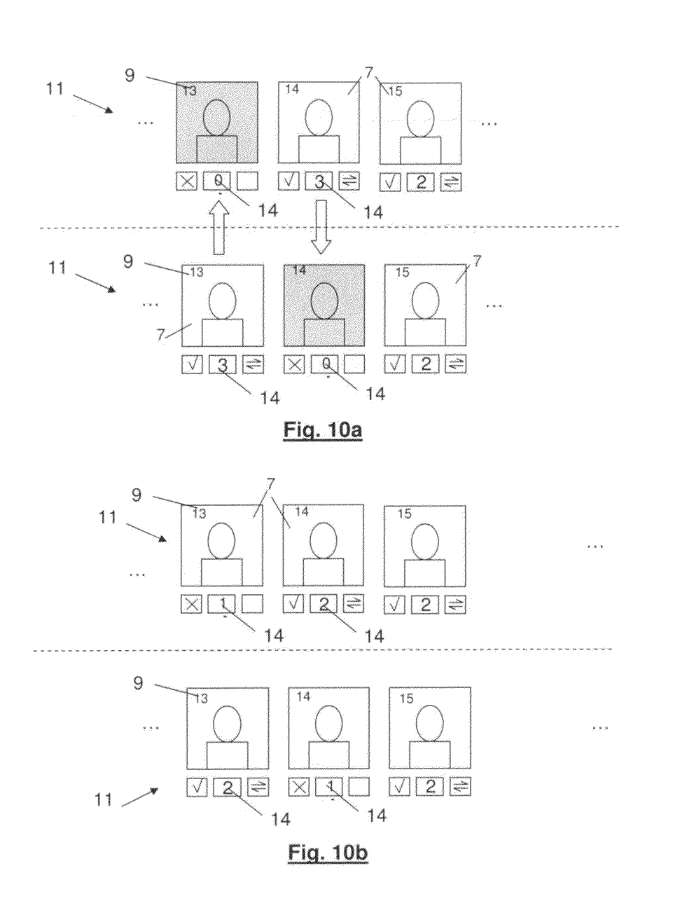

Repeated collectible elements 7 can be traded among different users, therefore a user can label those repeated collectible elements 7 as “tradable”. Therefore, a central server is responsible for matching users who have collectible elements 7 labeled as “tradable” that one user has but another has not, such as for example the situation shown in FIG. 10a. In this case, the collectible elements 7 will be traded, the central server recording in the database of owners of collectible elements 7 the trade between users and updating the identifiers of the collectible elements 7 so that each user can see them in his/her collection as shown in FIG. 10b.

Naturally multimedia containers are traded upon trading the collectible elements 7, therefore the users obtaining the collectible elements 7 will be able to access all their associated multimedia contents and audiovisual events.

To inform the user of the state of his/her collection 11 and the state thereof in relation to the rest of the users, the user can access a list of scores in which ones percentage of completed collection, number of collectible elements 7, number of collectible elements 7 which have been traded with other users, and number of times that an action relating to any of the user collectible elements 7 has been notified in a social network, will be able to be verified. The score thereof obtained from ones number of collectible elements 7 will be able to be verified each being weighted with a pre-established value by an administrator depending on the value to be awarded to each collectible element 7 and said score can be compared with the registered users having higher score to determine his/her relative position and to thus encourage the user to reach the level of said registered users who have a higher score by means of acquiring or trading collectible elements 7. To reinforce this incentive, awarding prizes to said users with higher score is envisaged, such as discounts on promotional items or tickets to events, these being announced to the rest of the users. To increase new user registration, the information relating to the registered users having higher score as well as the advantages that they have will be accessible to non-registered users, to encourage user registration and participation in collecting collectible elements 7.

Naturally it is envisaged that there are different collections, for example of a different theme, for example soccer players of different teams or movie actors and each user can register him/herself independently to the desired collections, being able to keep the user registration information when registering to a new collection.

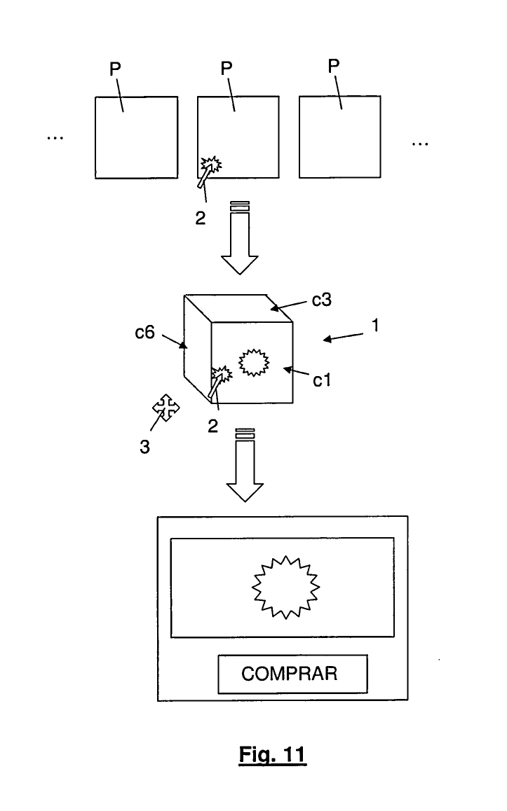

The method previously described can also be used for displaying catalogues or virtual shops, for example displaying different types of articles of clothing as the covers P of multimedia containers as shown in FIG. 11, displaying the different articles of clothing associated with each type of article of clothing as multimedia contents, for example images, on the cube. After selecting the type of article of clothing to be acquired, a buyer will thus be able to select the article of clothing of interest easily by means of browsing through the different faces of the cube 1. In this case, the audiovisual event can be the display of the characteristics of the article of clothing to be acquired as well as its price.

1. A method for managing and displaying multimedia contents (A, A1, A2, A3, A4, A5, A6, B, B2, B3, B4, B5, B6, B7, C) comprising the steps of
designating at least one multimedia container (10, 20, 30);
linking every designated multimedia container to multimedia contents
establishing for each multimedia container one of the linked multimedia contents as the cover (P) of the multimedia container;
displaying at least one cover of the multimedia container for selection; characterized in that upon selecting the cover of one of the displayed multimedia containers multimedia contents linked to said multimedia container are shown on the different faces (c1, c2, c3, c4, c5, c6) of a polyhedron allowing the transition of the multimedia contents on the different faces of the polyhedron by means of rotating the polyhedron on its different axes (X, Y, Z).

2. The method according to claim 1, characterized in that the polyhedron is a parallelepiped.

3. The method according to claim 1, characterized in that the polyhedron is a cube (1).

4. The method according to claim 1, characterized in that at least one of the multimedia contents (A, A1, A2, A3, A4, A5, A6, B, B2, B3, B4, B5, B6, B7, C) on the faces of the polyhedron is linked to an audiovisual event (eA1, eA2, eA5, eB2, eB3, eB5, eB6), the execution of said audiovisual event being triggered by selecting the multimedia content to which it is linked.

5. The method according to claim 1, characterized in that it comprises the subsequent step of modifying the multimedia contents (A, A1, A2, A3, A4, A5, A6, B, B2, B3, B4, B5, B6, B7, C) initially linked to a multimedia container (10, 20, 30) to update the multimedia contents on the different faces (c1, c2, c3, c4, c5, c6) of the polyhedron.

6. The method according to claim 1, characterized in that the number of different multimedia contents (A, A1, A2, A3, A4, A5, A6, B, B2, B3, B4, B5, B6, B7, C) linked to a multimedia container (10, 20, 30) is seven, one of them corresponding to the cover (P) and the rest corresponding to the different faces (c1, c2, c3, c4, c5, c6) of the polyhedron.

7. The method according to claim 1, characterized in that the number of different multimedia contents (A, A1, A2, A3, A4, A5, A6, B, B2, B3, B4, B5, B6, B7, C) linked to a multimedia container (10, 20, 30) is less than seven, at least one of the faces (c1, c2, c3, c4, c5, c6) of the polyhedron being empty.

8. The method according to claim 1, characterized in that it comprises the subsequent step of incorporating a customized multimedia content to one of the empty faces (c1, c2, c3, c4, c5, c6).

9. The method according to claim 1, characterized in that the multimedia contents (A, A1, A2, A3, A4, A5, A6, B, B2, B3, B4, B5, B6, B7, C) comprise images, said images being shown in the corresponding faces (c1, c2, c3, c4, c5, c6) of the polyhedron.

10. The method according to claim 1, characterized in that the multimedia contents (A, A1, A2, A3, A4, A5, A6, B, B2, B3, B4, B5, B6, B7, C) comprise videos, said videos being shown in the corresponding faces (c1, c2, c3, c4, c5, c6) of the polyhedron.

11. The method according to claim 1, characterized in that the linking of each multimedia container (10, 20, 30) to multimedia contents (A, A1, A2, A3, A4, A5, A6, B, B2, B3, B4, B5, B6, B7, C) and the establishment of one of the linked multimedia contents as the cover (P) of the multimedia container, as well as the designation of the multimedia contents which will be on each of the different faces (c1, c2, c3, c4, c5, c6) of the polyhedron are recorded in a multimedia container database 4.

12. The method according to claim 1, characterized in that identifiers (*A, *A1, *A2, *A3, *A4, *A5, *A6, *B, *B2, *B3, *B4, *B5, *B6, *B7, *C) of the respective multimedia contents (A, A1, A2, A3, A4, A5, A6, B, B2, B3, B4, B5, B6, B7, C) are recorded in the multimedia container database (4).

13. The method according to claim 1, claims, characterized in that the multimedia containers (10, 20, 30) form part of a finite set of elements.

14. The method according to claim 1, characterized in that each of the multimedia containers (10, 20, 30) forming part of a finite set of collectible elements (7) is associated with a set of users owning said multimedia container.

15. The method according to claim 1, characterized in that the multimedia containers (10, 20, 30) forming part of a finite set of collectible elements 7 are transferable from a user owning said multimedia container to a user not owning said multimedia container.

16. A system (100) for managing and displaying multimedia contents comprising:
storage means (102) for storing multimedia contents (A, A1, A2, A3, A4, A5, A6, B, B2, B3, B4, B5, B6, B7, C);
recording means (105) for designating multimedia containers (10, 20, 30) and linking them to the multimedia contents of the storage means, establishing for each multimedia container:
one of the multimedia contents as the cover (P) of the multimedia container and
other multimedia contents as the faces (c1, c2, c3, c4, c5, c6) of a polyhedron;
a server (103) for receiving connections from user client devices (104) and transmitting the covers of the multimedia containers to said user client devices and after receiving the cover selection from each user device, providing the contents linked to its multimedia container to be shown in the user client device on the different faces (c1, c2, c3, c4, c5, c6) of a polyhedron, allowing the user client device the transition of multimedia contents on the different faces of the polyhedron by means of rotating the polyhedron on its different axes (X, Y, Z).

17. The system (100) according to claim 1, characterized in that the storage means (102) also comprise audiovisual events (eA1, eA2, eA5, eB2, eB3, eB5, eB6) linked to the multimedia contents (A, A1, A2, A3, A4, A5, A6, B, B2, B3, B4, B5, B6, B7, C).

18. The system (100) according to claim 1, characterized in that the server (103) comprises means for receiving connections of administrator client devices (104) for creating new multimedia containers (10, 20, 30) or modifying the existing multimedia containers (10, 20, 30), linking them to other multimedia contents (A, A1, A2, A3, A4, A5, A6, B, B2, B3, B4, B5, B6, B7, C) of the storage means (102).

19. The system (100) according to claim 1, characterized in that the administrator client device (104) can incorporate multimedia contents (A, A1, A2, A3, A4, A5, A6, B, B2, B3, B4, B5, B6, B7, C) or audiovisual events (eA1, eA2, eA5, eB2, eB3, eB5, eB6) in the storage means (102), establishing or modifying links of said multimedia contents and audiovisual events in the recording means (105).
